(19) United States
(12) Patent Application Publication
(10) Pub. No.: US 2014/0016113 A1
(43) Pub. Date: Jan. 16, 2014

(54) DISTANCE SENSOR USING STRUCTURED LIGHT

(71) Applicant: MICROSOFT CORPORATION, Redmond, WA (US)

(72) Inventors: James A. Holt, Bellevue, WA (US); Mike M. Paull, Kenmore, WA (US); Raymond Xue, Issaquah, WA (US); Tetsuji Aoyagi, Yokohama (JP); Hisanori Kasai, Yokohama (JP); Kazufumi Higuchi, Yamagata (JP); Naoki Kanzawa, Sagamihara (JP); Toru Suzuki, Yamato (JP)

(73) Assignee: Microsoft Corporation, Redmond, WA (US)

(21) Appl. No.: 13/712,949

(22) Filed: Dec. 12, 2012

Related U.S. Application Data
(60) Provisional application No. 61/671,578, filed on Jul. 13, 2012.

(51) Int. Cl. G01C 3/08

(52) U.S. Cl. CPC G01C 3/08
USPC 356/3.11

(57) ABSTRACT

The subject disclosure is directed towards a distance sensor that outputs one or more (e.g., infrared) light patterns from a transmitting element. Signals from any reflective entity (e.g., a surface or object) within the sensor's range are captured by a receiving element. The captured image is digitized into digital data representing each light pattern, and the digital data is processed (e.g., including using triangulation) to determine distance data of the distance sensor relative to the reflective surface.

### BACKGROUND

Distance detection is useful in a number of scenarios, such as in robotics where the distance to an object or barrier needs to be sensed, such as to avoid a collision. Contemporary, commonly available infrared-distance sensors that perform distance detection are based on a Position Sensing Detector (PSD) receiving element that outputs a differential output based on the position of the centroid of a single reflected infrared spot.

Such PSD-type sensors are easily saturated by environmental sources of infrared energy, such as sunlight. The characteristics and formulation of the PSD element are also such that the receiving element acts as an antenna that is highly sensitive to near-field sources of electromagnetic/radio frequency interference (EMI/RFI), which may result in false or spurious distance readings.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology in which a distance sensor outputs one or more light patterns from a transmitting element that are detectable in an image captured by a receiving element via reflection from a reflective entity (e.g., a surface or object) when within range. Each light pattern detected by the receiving element is represented by digital data that are processed to determine distance data relative to the reflective surface.

In one aspect, there is described outputting a one or more light patterns at one or more different angles and receiving reflected signals corresponding to a captured image of each light pattern as reflected by a reflective entity. The reflected signal or signals are represented as digital data, which is processed, including to determine geometric movement corresponding to each received reflected signal, to compute a distance to the reflected surface.

In one aspect, an image that captures reflected infrared light patterns is scanned to process the image into digital data representative of one or more reflected infrared light patterns. The digital data is processed to calculate a distance to a reflective entity from which each infrared light pattern was reflected.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIGS. 1A and 1B are representations of a front view and side sectional view, respectively, of a distance sensor using structured light, according to one example embodiment.

FIG. 2 is a representation of a distance sensor coupled to a control board, according to one example embodiment.

FIG. 3 is a representation of a distance sensor's electrical section, according to one example embodiment.

FIG. 4A is a representation of a distance sensor transmitting two spots onto a surface for distance measurement, according to one example embodiment.

FIG. 4B is a representation of a distance sensor transmitting four spots onto an object for distance and elevation change measurement, according to one example embodiment.

FIG. 5 is a flow diagram showing example steps of distance measurement, according to one example embodiment.

FIGS. 6A, 6B and 6C are representations of how a received image is processed into data representative of transmitted spots, according to one example embodiment.

FIG. 7 is a representation of how triangulation may be used to compute distance, according to one example embodiment.

FIG. 8 is a block diagram representing an example computing environment into which aspects of the subject matter described herein may be incorporated.

### DETAILED DESCRIPTION

Various aspects of the technology described herein are generally directed towards transmitting one or more light patterns (e.g., at infrared frequencies) that are detected for distance sensing. In one implementation, a transmitting element transmits an optically focused infrared pattern of one or more spots or “dots” that are optically aligned to a receiving element's field of view. The reflected infrared pattern is gathered by a focusing lens in the receiving element onto the surface of an imager.

The position and alignment of the sensor's transmitting element may be fixed and known relative to the position and alignment of the sensor's receiving element. As a result, the change in the geometry information (e.g., the geometric centroid) of the transmitted infrared spot in the pattern versus the received geometric position data (e.g., the geometric position of the centroid) of each received spot in the pattern may be algorithmically calculated to produce an accurate distance to a reflective entity (e.g., an object or surface) within the sensor's/receiving element's field of view.

It should be understood that any of the examples herein are non-limiting. For example, infrared sensing is used in one implementation, however other spectrum frequencies may be used, such as applicable to other environments and applications. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and distance detection in general.

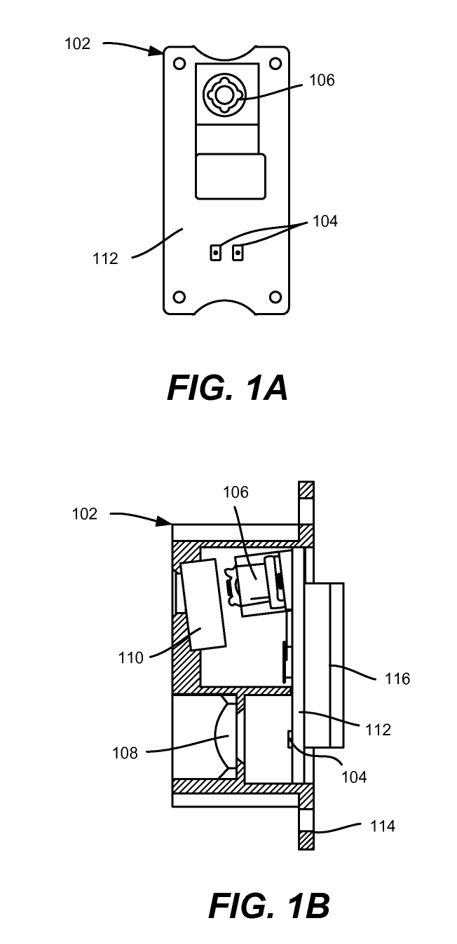

FIGS. 1A and 1B show a generally front representation and side (section) view, respectively, of an example implementation comprising components of one electronic distance measuring sensor 102. The exemplified sensor 102 utilizes an IR (infrared) pattern-transmitting (TX) element 104 and a receiving (RX) element 106, such as a camera. As can be readily appreciated, the transmitting element 104 may comprise one or more light emitting diodes (LEDs), which may transmit the light signal through a lens 108 and/or other optical mechanism to produce a desired output pattern. The receiving element 106, in one example implementation, may comprise a CMOS (Complementary Metal-Oxide Semiconductor) receiving element. Note that in FIG. 1A, the transmitting element 104 and a receiving element 106 are shown as visible from the front view, although they actually only may be visible through an intervening component such as a lens and/or filter.

For example, a bandpass filter 110 may be used to filter out undesirable received frequencies such as visible light. For noise reduction, a relatively narrow slice of the infrared wavelengths (e.g., 815 nM) may be used. One way to make the sensor 102 generally robust against sources of interference such as sunlight is to use the bandpass filter 110 in conjunction with a digital rolling shutter that is synchronized with strobing the IR transmission pattern. Strobing in general allows higher momentary output, as well as reduced energy consumption and generated heat.

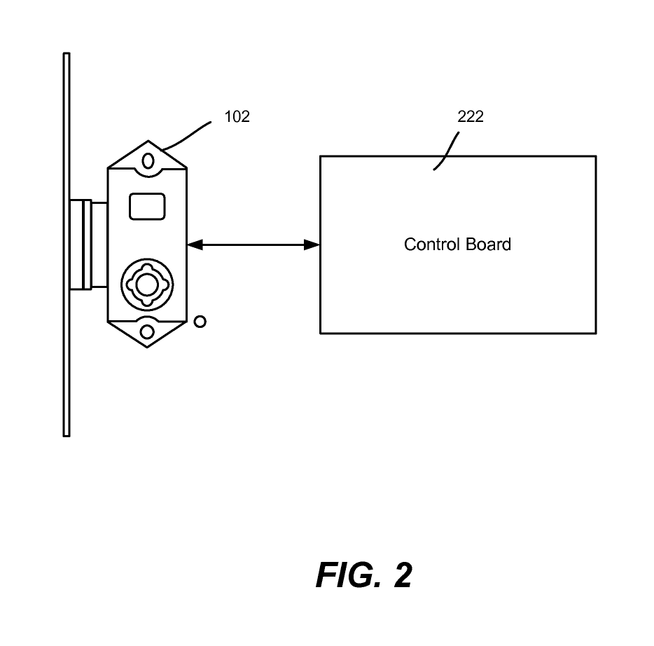

The various components of the sensor 102 may be coupled to a printed wiring board 112, and contained within a case/housing 114. The sensor 102 may be connected through any suitable connector 116 (FIG. 1A), or set of connectors to a control board 222, as generally shown in FIG. 2. The control board 222, may, for example, contain some or all of the circuitry that controls a robot or other mechanism that is configurable to benefit from a distance sensor as described herein.

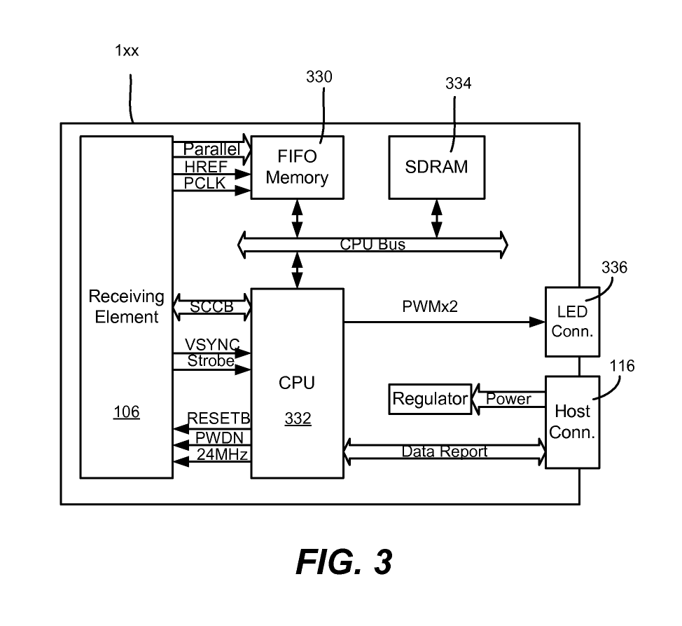

FIG. 3 shows an electrical diagram of components of one example sensing device, such as the electronic distance measuring sensor 102, including the receiving element 106 coupled to a memory 330, which in turn is coupled to a CPU 332 and further (e.g., SDRAM) memory 334; (either or both of the memories 330, 334 may comprise computer-readable storage media). In this way, the received data may be processed and used to compute distance. Because the data that are processed for distance corresponds to digital information, the device is more robust to interference.

Note that in the example of FIG. 3, an LED connector 336 is shown; the host connector may be the connector 116 shown in FIG. 1B. Notwithstanding, as can be readily appreciated, some of the components of FIG. 3 may be implemented on another board or the like, e.g., control board 222, and/or some control board components may be integrated into the device 102. For example, a custom chip may be used for some or all of the circuitry, which allows the circuitry to be packaged into the sensor. Thus, is it understood the division of components/circuitry among boards or the like is generally arbitrary, except possibly as dictated by a particular usage scenario. Further, other components may be present, e.g., an antenna and other wireless components may be used to broadcast distance information from a device sensor to a receiving entity.

In general, the transmitting element 104 may be a single emitter that transmits an optically focused IR pattern comprising one or more spots or “dots” that are optically aligned to the receiving element's field of view. The distance sensor thus may transmit IR light via optics, such as through a multi-lens array (e.g., the lens 108), a diffraction grating and/or mirror-based technology, which creates a pattern of one or more well-defined light spots. Alternatively, multiple IR light sources may be used, and indeed, this allows for different, per-spot parameters such as timing, intensity, signatures and/or the like to be used. An IR sensitive camera placed off-axis from the IR transmitter acquires any reflected spot pattern from a reflective surface within range, e.g., the reflected IR pattern is gathered by a focusing lens in the receiving element 106 onto the surface of the sensor's imager.

In general, the sensor works by analyzing the geometric movement of the spot, e.g., by processing to find the centroid. However, having multiple independent spots provides redundancy (and margin in the case of nearing a step for example, if configured so that one spot is further out than the other). Thus, while the examples herein show multiple spots being projected, even projecting a single spot provides the ability to distinguish distances with a relatively high degree of accuracy.

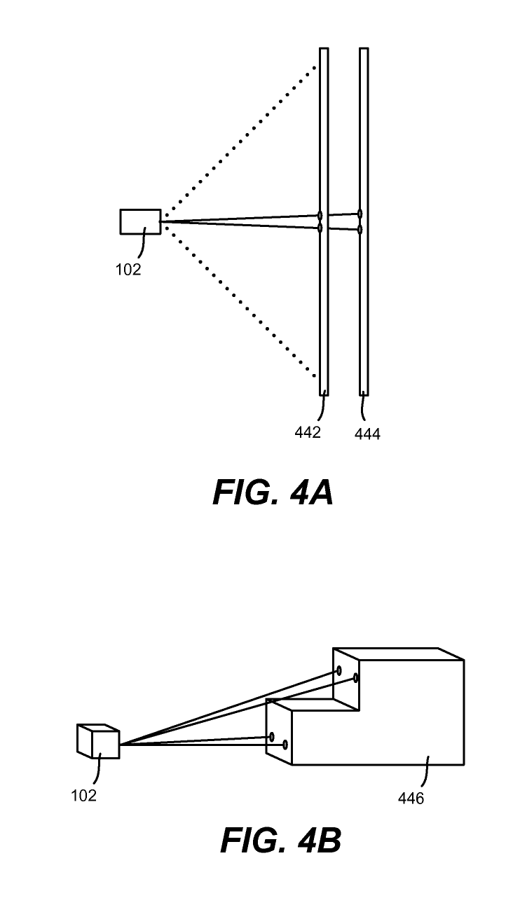

To this end, because the baseline physical distance between the IR transmitting element 104 and receiving element 106 is known, a triangulation algorithm, such as one exemplified below, may be used to determine distance. One or more spots in the projected pattern allow for computation of a distance result, e.g., as in the top view of FIG. 4A, where surface 442 represents a reflective surface at one distance and surface 444 represents a reflective surface at a different distance, the ellipses represent the spots, the solid lines represent the transmitted IR beams and the dotted lines represent the camera field of view; (none of the angles or sensor sizes are meant to represent any actual implementations). Even more spots in the projected pattern allow the detection of a change in the reflective entity's elevation and/or orientation, as in the simplified side angled view of FIG. 4B where the sensor 102 detects an example object 446; (again, none of the angles or sensor sizes are meant to represent any actual implementations).

A processor such as the CPU 332 may run an algorithm or set of algorithms to calculate the geometric offsets of each spot, e.g., based upon its centroid. Along with a distance, a change in floor elevation, and/or surface orientation may be computed.

The distance calculation is generally invariant to the spot intensity (unlike present sensors), and is based upon digital data and thus less susceptible to interference. The IR intensity may be dynamically adaptive to provide a variable (e.g., a desired or more suitable) exposure. For example, when the dot or dots are output onto a highly reflective surface, less intensity may be output, and conversely more intensity may be output for a surface that does not reflect particularly well. Any suitable frame rate may be used depending on the application, e.g., 15 to 240 frames per second, or even higher, with a suitable camera selected based upon the needed/desired frame rate. Frames may be skipped, which may be a programmable parameter. The faster the frame rate, the less latency, such as for obstacle detection, and the more data is available for processing (e.g., to discard, with a high confidence level due to a large number of frames, a small number of frames that are likely just detecting noise). The timing may be such that the output is turned on and off, with the data sensed while off being subtracted as background from the data sensed while on. More generally, the transmitting element may, if desired for a given scenario, output the light patterns with a first intensity corresponding to an on state and a second intensity (which may be zero) corresponding to an off state, for relative evaluation (e.g., background subtraction) of what is being sensed.

A signature may be encoded into the IR signal when on, e.g., via pulsing, to further provide robustness. In this way, for example, a reflected signal received at an allowed frequency and/or at the correct synchronized time, but that does not have the correct signature, may be rejected as likely being from interference.

The detected distance may be used for obstacle detection, for example. The geometry and/or displacement of each spot may be used in the computation. Note that in a situation where no reflection is sensed (basically corresponding to “infinite” distance), the computation may indicate no obstacle. For example, a no obstacle situation where the sensor is angled forward may indicate that no obstacle is in the sensing range, while if a sensor is angled downward, may be used for cliff sensing.

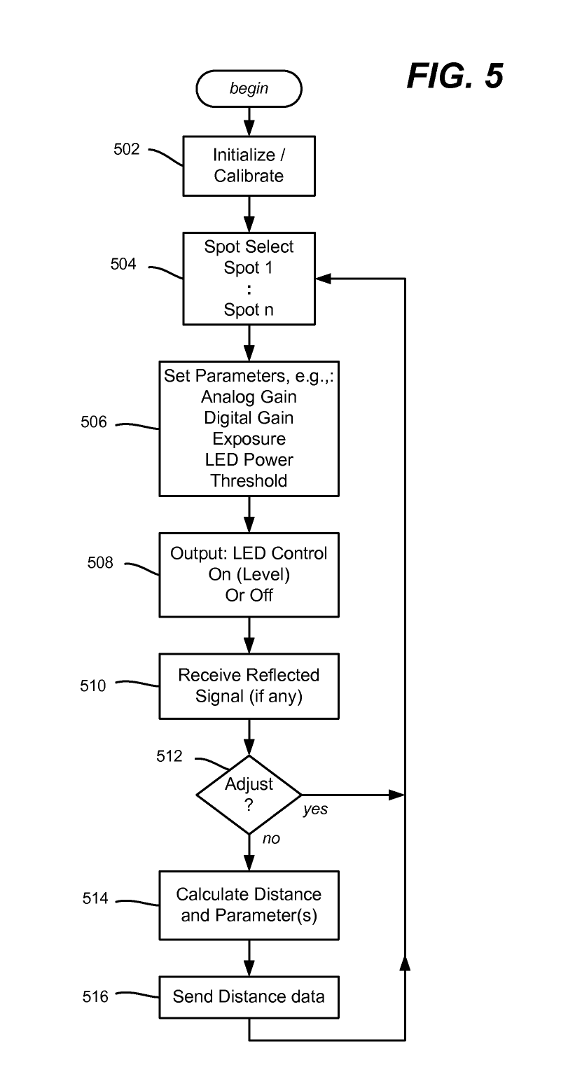

FIG. 5 is a flow diagram representing example steps that may be taken to sense and compute the distance to a surface (as well as possibly elevation and/or orientation). At step 502, any initialization and/or calibration of the sensor is represented, which may include any one-time or infrequent calibration (e.g., for the lens distortion table) and regular initialization and calibration (e.g., each time the sensor is powered up).

Step 504 represents spot selection, such that if multiple spots are being transmitted, each spot may have different parameters (e.g., in an implementation having a separate transmitter per spot). Step 506 sets the parameters for each selected spot, e.g., including analog gain, digital gain, exposure, LED power, threshold (for digitizing), timing, signatures, and so forth.

Step 508 represents outputting the emitter (LED), which may be strobed, pulsed, and so forth as described herein. The “on” state may have different intensity levels such as normal, high, super-high, and so on. Step 510 represents capturing the image, including receiving any reflected signal or signals that is in the receiving element's field of view.

Step 512 represents determining whether an adjustment is needed, e.g., based upon a judgment of the image peak intensity or the like. This may be used to adjust intensity, for example, to adapt for the reflectivity of the surface. Note that if no reflection is sensed that meets the digitizing threshold, or nothing indicates a spot and/or any signature test is not met, this may be because of poor surface reflectivity or because no surface is within the sensing range. Thus, at least one adjustment may be attempted before determining that no surface exists.

Step 514 represents computing the distance (as well as possibly elevation and/or orientation), e.g., after any adjustments are made as needed to obtain appropriate data. Note that the distance may be infinite, e.g., nothing was reflected. Distance computation based upon triangulation is described below. Step 514 also represents revising any parameters. Step 516 represents sending the computed distance data (as well as elevation and/or orientation results) to the receiving entity, e.g., a computer system or controller, such as one coupled to or incorporated into a mobile mechanism (e.g., robot).

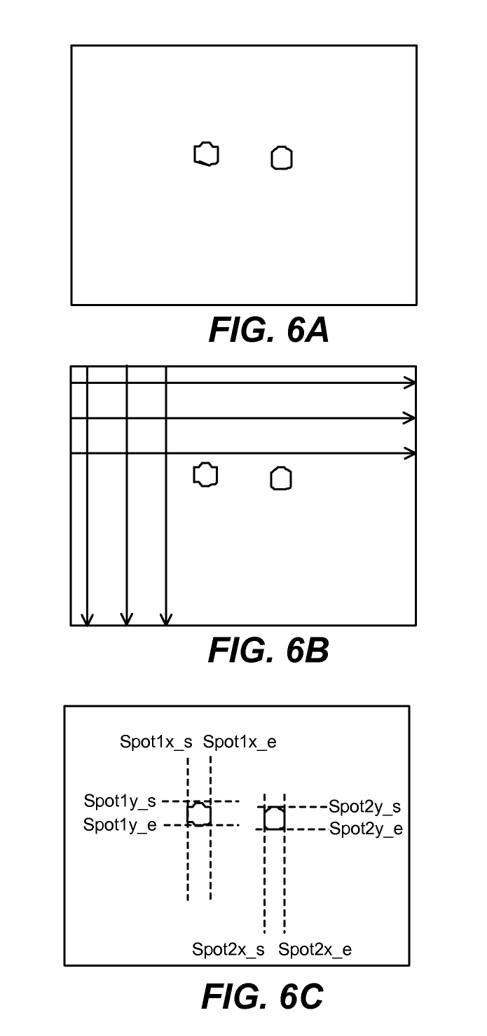

Turning to an example of one sensor distance measurement algorithm, FIG. 6A represents an example of two captured image light patterns (spots) represented in binary data, such as from using analog data to determine whether a certain reflected signal intensity is achieved relative to a threshold value, and setting a binary image array or the like to one (1) if the threshold is achieved, or zero (0) if not, or alternatively keeping the coordinates only of those that achieve the threshold. Thus, a step may buffer the pixel positions, in X-Y coordinates, that have a binary one (“1”) value indicative of a (threshold-achieved) spot.

FIG. 6B represents (in a pictorial sense) scanning the buffered values in another step, to search for the smallest X, Y coordinates in which four continuous binary “1” values appear in the buffered pixel position data. Note that four continuous binary “1” values may be used based upon the spot size and/or experimental results, however other search criteria may be used. In another step, the same (or a similar) search is carried out with the largest X, Y coordinates. The coordinate pairs resulting from scanning may be designated as (spot1x_start, spot1y_start), and (spot1x_end, spot1y_end). For additional spots up to n spots, a search may be carried out, e.g., resulting in coordinate pairs representing up to the nth spot; (spotnx_start, spotny_start), and (spotnx_end, spotny_end). Note that in the event that the search criteria is not met (or there are not enough buffered values to be considered a spot), an adjustment may be made (e.g., in intensity) and a new image captured.

FIG. 6C represents an n value for two spots, where “s” represents start and “e” represents end, and the dashed lines point out the determined coordinates. These are shown for the two example spots “1” and “2” as (Spot1x_s, Spot1y_s); (Spot1x_e, Spot1y_e), and (Spot2x_s, Spot2y_s); (Spot2x_e, Spot2y_e).

In another step, the center coordinate of each spot may be estimated, such as by:

Spot1_{—}X=(spot1x_start+spot1x_end)/2

and

Spot1_{—}Y=(spot1y_start+spot1y_end)/2.

This median point (e.g., corresponding to the center of gravity/centroid) computation provides reasonable results even when the spot shape is deformed by the reflection surface (which causes a move in the median point and thus somewhat imprecise results). A center of mass or other computation alternatively may be used as desired. For purposes of explanation, the “spot center” is used hereinafter to refer to the computed X and Y coordinates representing a given spot, even if not actually a true “center” in all instances.

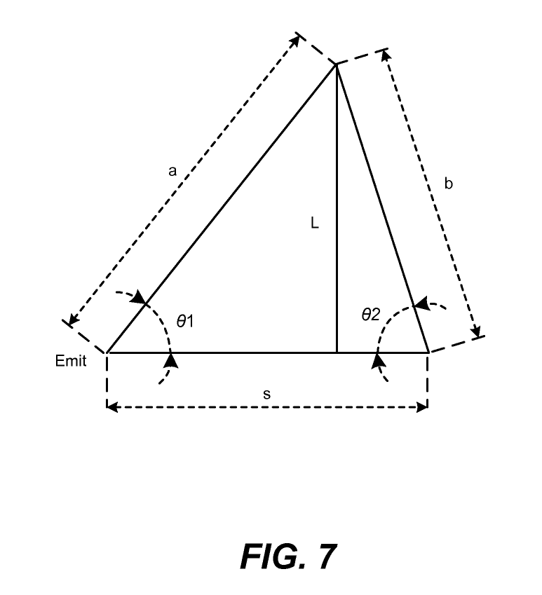

From the position of the spot center, another step is based upon defining the incident angle “θ2” (FIG. 7) as the incident angle of the reflected beam coming into sensor. Due to known image distortion caused by a lens, this incident angle may be corrected by “distortion table” that is dependent on the lens being used. Calibration or the like may be used to fill in the table for a given sensor/lens.

Because the emission angle “θ1” is mechanically fixed, the following example triangulation calculation, generally represented in FIG. 7, may be used to determine the distance:

a·sin θ1=b·sin θ2 (1)

a·cos θ1+b·cos θ2=s (2)

and

a=s/(cos θ1+(sin θ1−cos θ2)/sin θ2)

therefore L equals:

L=a·sin θ1.

For multiple spots, a distance to each spot may be independently computed and sent as independent distance data. Alternatively, before sending the distance data, some or all of the independent data may be combined in some way, analyzed for certain situations, and so forth.

### Example Computing Device

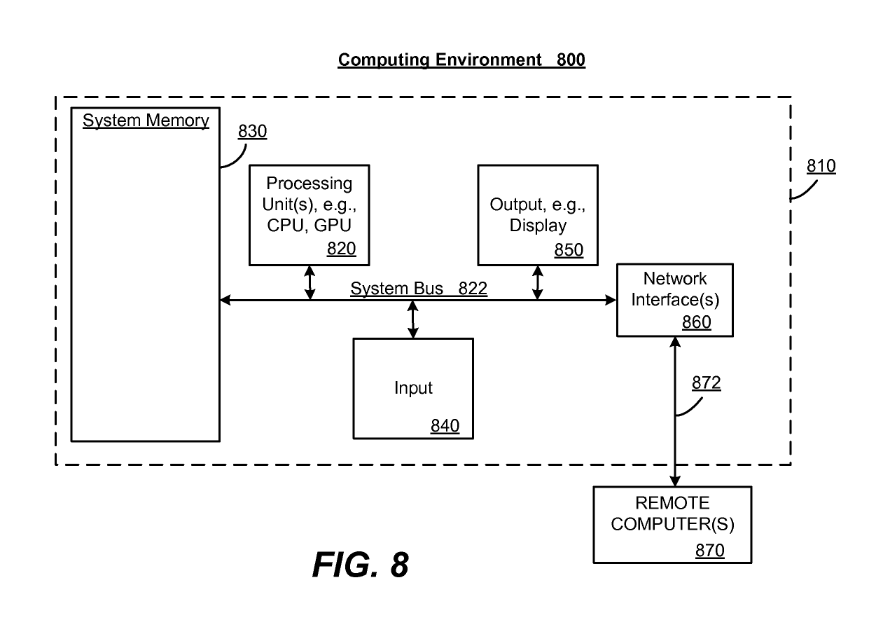

As mentioned, advantageously, the techniques described herein can be applied to any device. It can be understood, therefore, that handheld, portable and other computing devices and computing objects of all kinds including robots are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. In addition, the computing system environment 800 is not intended to be interpreted as having any dependency relating to any one or combination of components illustrated in the example computing system environment 800.

With reference to FIG. 8, an example remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer-readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

1. A system comprising:
a distance sensor including a transmitting element and a receiving element, the distance sensor configured to output one or more light patterns from the transmitting element that are detectable in an image captured by the receiving element via reflection from a reflective entity when within range, in which each light pattern detected by the receiving element is represented by digital data that are processed to determine distance data relative to the reflective entity.

2. The system of claim 1 wherein the receiving element captures an image corresponding to the one or more reflected light patterns reflected from a reflective entity within range, and wherein coordinates representative of the one or more reflected light patterns are processed using triangulation to determine the distance data relative to the reflective entity.

3. The system of claim 1 wherein the transmitting element comprises at least one infrared emitter that outputs the one or more light patterns.

4. The system of claim 1 wherein the transmitting element comprises a plurality of infrared emitters that output a plurality of light patterns, or at least one infrared emitter that outputs a plurality of light patterns via optics.

5. The system of claim 1 wherein the transmitting element strobes at least one of the one or more light patterns in synchronization with a rolling shutter of the receiving element.

6. The system of claim 1 wherein the transmitting element outputs at least one of the one or more light patterns with a first intensity corresponding to an on state and a second intensity corresponding to an off state for relative evaluation.

7. The system of claim 1 wherein the transmitting element outputs at least one of the one or more light patterns with an encoded signature.

8. The system of claim 1 further comprising a bandpass filter that determines a frequency range of the one or more light patterns that are detectable by the receiving element.

9. The system of claim 1 wherein the transmitting element outputs a plurality of light patterns, the receiving element detects the plurality of light patterns, and wherein coordinates representative of the plurality of light patterns are processed to determine elevation data or orientation data, or both elevation data and orientation data.

10. The system of claim 1, wherein no light pattern detected by the receiving element is indicative of no reflective entity in range.

11. The system of claim 1, wherein the transmitting element is dynamically controllable in intensity.

12. The system of claim 1, wherein the sensor is coupled to a mobile mechanism to provide for obstacle detection.

13. In a computing environment, a method comprising:
outputting one or more light patterns;
receiving one or more reflected signals corresponding to a captured image of the one or more light patterns as reflected by a reflective entity, in which the one or more reflected signals are represented as digital data; and
processing the digital data, including to determine geometric movement corresponding to at least one received reflected signal, to compute a distance to the reflective entity.

14. The method of claim 13 further comprising:
adjusting an intensity of at least one of the one or more light patterns.

15. The method of claim 13 further comprising:
digitizing the captured image into the digital data.

16. The method of claim 13 wherein processing the digital data comprises performing triangulation based on the one or more reflected signals and a distance relationship between a transmitter that outputs the one or more light patterns and a receiver that receives the one or more reflected signals.

17. The method of claim 13 further comprising, processing the digital data to compute an elevation or orientation change, or both.

18. One or more computer-readable storage media having computer-executable instructions, which when executed perform steps, comprising:
scanning an image that captures one or more reflected infrared light patterns to process the image into digital data representative of the one or more reflected infrared light patterns; and
processing the digital data to calculate a distance to and at least one of a floor elevation of or surface orientation of a reflective entity from which the one or more infrared light patterns were reflected.

19. The one or more computer-readable storage media of claim 18 having further computer-executable instructions comprising, dynamically adapting an intensity of a transmitter that outputs at least one infrared light pattern.

20. The one or more computer-readable storage media of claim 18 having further computer-executable instructions comprising, modifying a threshold value used in obtaining the digital data representative of the one or more reflected infrared light patterns.
